(19) United States
(12) Patent Application Publication
(10) Pub. No.: US 2020/0090603 A1
(43) Pub. Date: Mar. 19, 2020

(54) DISPLAY IMAGE ADJUSTING METHOD, DISPLAY DEVICE, AND COMPUTER READABLE STORAGE MEDIUM

(71) Applicants: Chongqing HKC Optoelectronics Technology Co., Ltd., Chongqing (CN); HKC Corporation Limited, Shenzhen (CN)

(72) Inventor: Wenxin Li, Chongqing (CN)

(21) Appl. No.: 16/254,625

(22) Filed: Jan. 23, 2019

Related U.S. Application Data
(63) Continuation of application No. PCT/CN2018/111430, filed on Oct. 23, 2018.

(30) Foreign Application Priority Data
Sep. 13, 2018 (CN) 201811072391.2

(51) Int. Cl. G09G 3/36

(52) U.S. Cl. CPC G09G 3/3607; G09G 3/3696; G09G 2320/0673; G09G 2320/0252; G09G 2320/10

(57) ABSTRACT

The present application discloses a display image adjusting method, including: acquiring gray scale data of an input image frame of a display device; determining an adjusting value of a reference voltage of liquid crystal deflection based on the gray scale data; and adjusting the reference voltage of liquid crystal deflection according to the adjusting value.

### CROSS REFERENCE TO RELATED APPLICATIONS

The present application is a Continuation Application of PCT Application No. PCT/CN2018/111430 filed on Oct. 23, 2018, which claims the benefit of Chinese Patent Application No. 201811072391.2 filed on Sep. 13, 2018. All the above are hereby incorporated by reference.

### TECHNICAL FIELD

The present application relates to the technical field of display, in particular, relates to a display image adjusting method, a display device, and a computer readable storage medium.

### BACKGROUND

An increasing number of apparatus having display functions, for example, televisions, smart phones and etc., has been accessing into people's domestic life and work with the help of technological improvement. In the technical field of display, the liquid crystal is driven by a driving voltage. Different images could be displayed, by controlling an open or closing of different pixels according to differences of driving voltages. Images would be blurry when displayed dynamically, due to an insufficient charging interval for the over driver technology (referred to as OD hereinafter).

At present, when dynamic images are displayed by the display device, the required voltage could not be output continuously and consistently for driving the liquid crystal to display, because of an insufficient driving charging interval. This may lead to an unstable display, and further to display defects and an inferior display performance.

### SUMMARY

The present application aims to provide a display image adjusting method, a display device, and a computer readable storage medium, which intends to solve the problem that when the display device displays a dynamic picture, the required voltage could not be output continuously and consistently for driving display of the liquid crystal, resulting in an unstable display, display defects, and an inferior display performance, because of an insufficient driving charging interval.

To fulfill the above-mentioned objectives, the present application provides a display image adjusting method. The method includes the following steps:

acquiring gray scale data of an input image frame of the display device;

determining an adjusting value of a reference voltage of liquid crystal deflection based on the gray scale data;

adjusting the reference voltage of liquid crystal deflection according to the adjusting value, to adjust an over driver value.

Optionally, the operation of determining an adjusting value of a reference voltage of liquid crystal deflection based on the gray scale data may include:

determining gray scale data of a current input image frame from the gray scale data of the input image frame, and marking the gray scale data of the current input image as a first gray scale data;

determining gray scale data of a previous input image frame from the gray scale data of the input image frame, and marking the gray scale data of the previous input image as a second gray scale data;

determining the adjusting value of the reference voltage of liquid crystal deflection based on the first gray scale data and the second gray scale data.

Optionally, the operation of determining an adjusting value of a reference voltage of liquid crystal deflection based on the first gray scale data and the second gray scale data includes:

determining an average gray scale value of the previous image frame based on the first gray scale data, and marking the average gray scale value of the previous image frame as a first average gray scale value;

determining an average gray scale value of the current image image based on the second gray scale data, and marking the average gray scale value of the current image image as a second average gray scale value;

determining the adjusting value of the reference voltage of liquid crystal deflection based on the first gray scale value and the second gray scale value.

Optionally, the adjusting value of the reference voltage of liquid crystal deflection is determined by a look-up table of gray scale value and voltage of liquid crystal deflection, based on the first gray scale value and the second gray scale value.

Optionally, after the operation of determining an adjusting value of a reference voltage of liquid crystal deflection based on the gray scale data, the method further includes:

judging if the reference voltage of liquid crystal deflection is placed between a first preset reference voltage and a second preset reference voltage, after the reference voltage is adjusted according to the adjusting value;

if not, ending a flow process and controlling a voltage output according to a current reference voltage of liquid crystal deflection;

if yes, executing the reference voltage of liquid crystal deflection according to the adjusting value, to adjust the over driver value.

Optionally, a plurality of displaying modes are provided in the display device. The operation of determining the adjusting value of the reference voltage of liquid crystal deflection based on the gray scale data may include:

determining a current display mode of the display device;

determining the adjusting value of the reference voltage of liquid crystal deflection, based on the gray scale data and the current display mode.

Optionally, after the operation of adjusting the reference voltage of liquid crystal deflection according to the adjusting value, to adjust the over driver value, the method may further include:

acquiring an image effect after the reference voltage of liquid crystal deflection is adjusted;

determining an effect difference when the image effect does not reach a preset effect;

determining a new adjusting value of the reference voltage of liquid crystal deflection, based on the effect difference, and adjusting the reference voltage of liquid crystal deflection according to the new adjusting value, so that the output image effect reaches the preset effect.

Optionally, after the operation of adjusting the reference voltage of liquid crystal deflection according to the adjusting value, to adjust the over driver value, the method may further include:

determining an adjusted display mode, after a display mode of the display device is adjusted;

redetermining the adjusting value of the reference voltage of liquid crystal deflection, based on the adjusted display mode;

adjusting the reference voltage of liquid crystal deflection, based on redetermined adjusting value.

Furthermore, on the other hand, the present application further provides a display device to fulfill the above-mentioned objectives. The display device includes: a memory, a processor, and a computer program stored in the memory and executed by the processor. The computer program performs following steps, when executed by the processor:

acquiring gray scale data of an input image frame of the display device;

determining an adjusting value of a reference voltage of liquid crystal deflection based on the gray scale data; and

adjusting the reference voltage of liquid crystal deflection according to the adjusting value, to adjust an over driver value.

Moreover, to fulfill the objectives mentioned above, the present application further provides a computer readable storage medium. The computer readable storage medium stores the display image adjusting program. The display image adjusting program performs the following steps when executed by the processor:

acquiring gray scale data of an input image frame of the display device;

determining an adjusting value of a reference voltage of liquid crystal deflection based on the gray scale data; and

adjusting the reference voltage of liquid crystal deflection according to the adjusting value, to adjust an over driver value.

The present application shortens a response time of the liquid crystal by means of acquiring gray scale data of the input image frame of the display device, determining the adjusting value of a reference voltage of liquid crystal deflection based on the gray scale data, and adjusting the reference voltage of liquid crystal deflection according to the adjusting value, to adjust the over driver value, which provides an sufficient voltage to ensure the effect of the liquid crystal display, improves stability of the liquid crystal display, and further ensures the image effect of liquid crystal display.

### BRIEF DESCRIPTION OF THE DRAWINGS

FIG. 1 is a structural schematic diagram of the display device of hardware execution environment involved in the solution of an exemplary embodiment of the present application;

FIG. 2 is a flow diagram of an exemplary embodiment of the display image adjusting method in the present application;

FIG. 3 is a flow diagram of determining an adjusting value of a reference voltage of liquid crystal deflection based on the gray scale data in an exemplary embodiment of the present application;

FIG. 4 is a schematic diagram of determining the adjusting value of the reference voltage of liquid crystal deflection based on the first gray scale data and the second gray scale data in an exemplary embodiment of the present application;

FIG. 5 is a schematic diagram showing the look-up table of gray scale value and voltage of liquid crystal deflection in an exemplary embodiment of the present application;

FIG. 6 is a schematic flow diagram of determining the adjusting value of the reference voltage of liquid crystal deflection based on the gray scale data in an exemplary embodiment of the present application;

FIG. 7 is a schematic flow diagram of another exemplary embodiment of the display image adjusting method of the present application.

The implementation, functional features and advantages of the present application will be further described referring to the drawings.

### DETAILED DESCRIPTION OF THE EMBODIMENTS

It should be understood that the specific embodiments described herein are merely illustrative of the present application and not for limitation.

The main solution of the exemplary embodiments of the present application lies in: acquiring gray scale data of an input image frame of the display device, determining an adjusting value of a reference voltage of liquid crystal deflection based on the gray scale data, and adjusting the reference voltage of liquid crystal deflection according to the adjusting value, to adjust an over driver value.

At present, when dynamic images are displayed by the display device, the required voltage could not be output continuously and consistently for driving display of the liquid crystal, because of an insufficient charging interval. This may lead to an unstable display, and further to display defects and an inferior image effect. The present application provides a solution and shorten a response time of the liquid crystal by acquiring gray scale data of an input image frame of the display device, determining an adjusting value of a reference voltage of liquid crystal deflection based on the gray scale data, and adjusting the reference voltage of liquid crystal deflection according to the adjusting value, to adjust an over driver value. It provides a sufficient voltage to ensure the effect of the liquid crystal display, improves stability of the liquid crystal display, and ensures the image effect of the liquid crystal display.

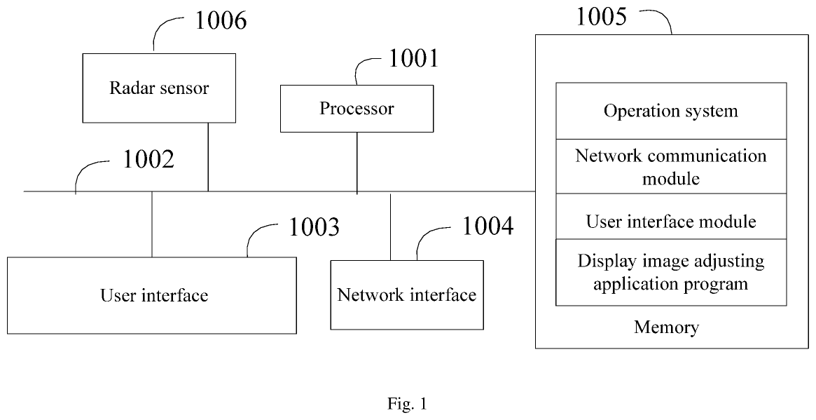

Referring to FIG. 1, which is a structural schematic diagram of the display device of hardware execution environment involved in the solution of an exemplary embodiment of the present application.

As shown in FIG. 1, the display device may include: a processor 1001, taking CPU for example, a network interface 1004, a user interface 1003, a memory 1005, and a communication bus 1002. The communication bus is configured for connection and communication between the components mentioned above. The user interface 1003 may also include a display, an input unit such as a keyboard, and optionally the user interface may further include a standard wired interface and a wireless interface. The network interface 1004 may optionally include a standard wired interface, and a wireless interface (such as a WI-FI interface). The memory 1005 may be a SRAM memory, or a non-volatile memory such as a disk memory. The memory 1005 optionally may further be a storage device that is independent from the processor 1001 described above.

Optionally, the display device may further includes a camera, a radio frequency circuit, a sensor, a voice frequency circuit, a WiFi module and etc.

It should be understood by the skilled in the art that the terminal structure shown in FIG. 1 does not constitute a limitation of the display device, and may include more or less components than those illustrated, or include some components combined, or include different component arrangements.

As shown in FIG. 1, the memory, as a computer readable storage medium, may include an operation system, a network communication module, a user interface module and a program for display adjustment.

In the display device shown in FIG. 1, the network interface 1004 is mainly configured to connect with the back-end server and to communicate data with the back-end server. The user interface 1003 is mainly configured to connect with the client (a user-end), and to communicate data with client. And processor 1001 could be configured to call the display image adjusting program stored in the memory 1005, and to execute the following operations:

acquiring gray scale data of the input image frame of the display device;

determining the adjusting value of the reference voltage of liquid crystal deflection based on the gray scale data;

adjusting the reference voltage of liquid crystal deflection according to the adjusting value, to adjust the over driver value.

Further, the processor 1001 may be configured to call the display image adjusting program stored in the memory 1005, and to execute the following operations:

determining gray scale data of a current input image frame from the gray scale data of the input image frame, and marking the gray scale data of the current input image as a first gray scale data;

determining gray scale data of a previous input image frame from the gray scale data of the input image frame, and marking the gray scale data of the previous input image as a second gray scale data;

determining the adjusting value of the reference voltage of liquid crystal deflection based on the first gray scale data and the second gray scale data.

Further, the processor 1001 may be configured to call the display image adjusting program stored in the memory 1005, and to execute the following operations:

determining an average gray scale value of the previous image frame based on the first gray scale data, and marking the average gray scale value of the previous image frame as a first average gray scale value;

determining an average gray scale value of the current image image based on the second gray scale data, and marking the average gray scale value of the current image image as a second average gray scale value;

determining the adjusting value of the reference voltage of liquid crystal deflection based on the first gray scale value and the second gray scale value.

Further, the processor 1001 may be configured to call the display image adjusting program stored in the memory 1005, and to execute the following operations: determining the adjusting value of the reference voltage of liquid crystal deflection by a look-up table of gray scale value and liquid crystal deflection voltage, based on the first gray scale value and the second gray scale value.

Further, after the operation of determining the adjusting value of a reference voltage of liquid crystal deflection based on the gray scale data, the processor 1001 may be configured to call the display image adjusting program stored in the memory 1005, and to execute the following operations:

judging if the reference voltage of liquid crystal deflection is placed between a first preset reference voltage and a second preset reference voltage, after adjusted according to the adjusting value;

if not, ending a flow process and controlling a voltage output according to a current reference voltage of liquid crystal deflection;

if yes, executing the reference voltage of liquid crystal deflection according to the adjusting value, to adjust the over driver value.

Further, a plurality of display modes could be provided in the display device, and the processor 1001 may be configured to call the display image adjusting program stored in the memory 1005, and to execute the following operations:

determining a current display mode of the display device;

determining the adjusting value of the reference voltage of liquid crystal deflection, based on the gray scale data and the current display mode.

Further, after the operation of adjusting the reference voltage of liquid crystal deflection according to the adjusting value, to adjust the over driver value, the processor 1001 may be configured to call the display image application program stored in the memory 1005, and to execute the following operations:

acquiring an image effect after the reference voltage of liquid crystal deflection is adjusted;

determining an effect difference when the image effect does not reach a preset effect;

determining a new adjusting value of the reference voltage of liquid crystal deflection, based on the effect difference, and adjusting the reference voltage of liquid crystal deflection according to the new adjusting value, and the preset effect is reached.

Further, after the operation of adjusting the reference voltage of liquid crystal deflection according to the adjusting value, to adjust the over driver value, the processor 1001 may be configured to call the display image adjusting program stored in the memory 1005, and to execute the following operations:

determining an adjusted display mode, after a display mode of the display device is adjusted;

redetermining the adjusting value of the reference voltage of liquid crystal deflection, based on the adjusted display mode;

adjusting the reference voltage of liquid crystal deflection, based on redetermined adjusting value.

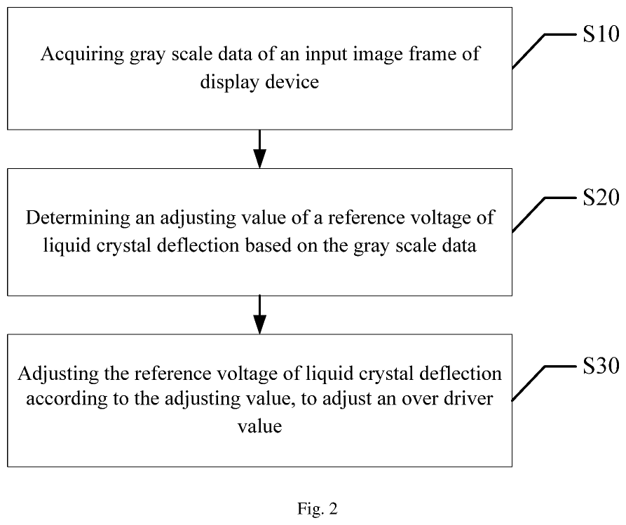

Referring to FIG. 2, the present application provides a display adjusting method. The method comprises the following steps:

step S10, acquiring gray scale data of the input image frame of the display device;

In the present exemplary embodiment, the display device may output distinct display images, according to distinct input signals, which displays dynamic images made up by individual image frames. In the process of displaying by the display device, the current image image and the gray scale data thereof are obtained. The gray scale data ranges from 0-255. The gray scale data could certainly be gray data of a single pixel of one image frame, or it could be an average gray scale value of the whole image frame, or it could be an average gray scale value of an optional part of pixels, or it could be gray scale data with certain weighting function taken from the whole image frame.

Optionally, in the present exemplary embodiment, the acquired gray scale data of the input image frame is an average gray scale value of a current input image frame.

The gray scale data may not simply include the gray scale data of current input image frame, but may also include the gray scale data of the previous input image frame. With the gray scale data of previous few input image frames being a set, previous gray scale data has been formed according to setting mode, which serves as the input gray scale data together with the gray scale data of the current input frames.

According to distinct selection, the gray scale data of the input image frame may include gray scale data of a current input image frame and/or gray scale data of a previous input image frame.

Step S20, determining the adjusting value of the reference voltage of liquid crystal deflection based on the gray scale data.

A correlation relationship has been established in advance between gray scale data of the displayed image of the display device and reference voltage of liquid crystal deflection (VCOM). That is, the look-up table of gray scale value and voltage of liquid crystal deflection has been established in advance.

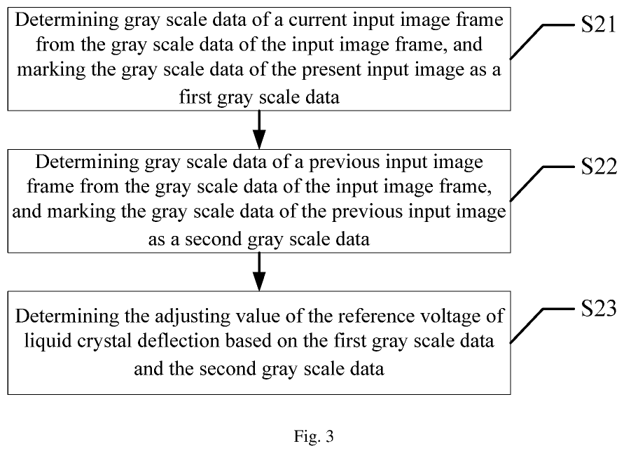

When the gray scale data is the gray scale data of the current input image frame, the adjusting value of VCOM can be obtained by the look-up table based on the gray scale data of the current image image. The adjusting value of the VCOM could be a final value of the VCOM, or it could be an adjusting value to obtain the final VCOM value.

Whereas, when the gray scale data includes the gray scale data of the current and previous input image frames, with FIG. 3 referred to, the operation of determining an adjusting value of a reference voltage of liquid crystal deflection based on the gray scale data includes:

step S21, determining gray scale data of a current input image frame from the gray scale data of the input image frame, and marking the gray scale data of the current input image as a first gray scale data;

step S22, determining gray scale data of a previous input image frame from the gray scale data of the input image frame, and marking the gray scale data of the previous input image as a second gray scale data;

step S23, determining the adjusting value of the reference voltage of liquid crystal deflection based on the first gray scale data and the second gray scale data.

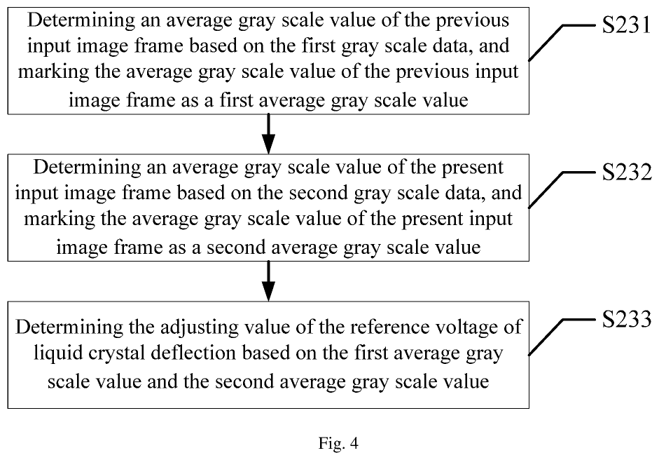

A mapping relationship has been established in advance between previous image frame, current image image and liquid crystal deflection. When the gray scale data is obtained, the gray scale data of the previous image frame (the first gray scale data) and the gray scale data of the current image image (the second gray scale data) have been extracted. The reference voltage of liquid crystal deflection is determined based on the first gray scale data and the second gray scale data.

Whereas, in one exemplary embodiment, FIG. 4 is referred to, in which the operation of determining an adjusting value of a reference voltage of liquid crystal deflection based on the first gray scale data and the second gray scale data includes:

step S231, determining an average gray scale value of the previous image frame based on the first gray scale data, and marking the average gray scale value of the previous image frame as a first average gray scale value;

step S232, determining an average gray scale value of the current image image based on the second gray scale data, and marking the average gray scale value of the current image image as a second average gray scale value;

step S233, determining the adjusting value of the reference voltage of liquid crystal deflection based on the first gray scale value and the second gray scale value.

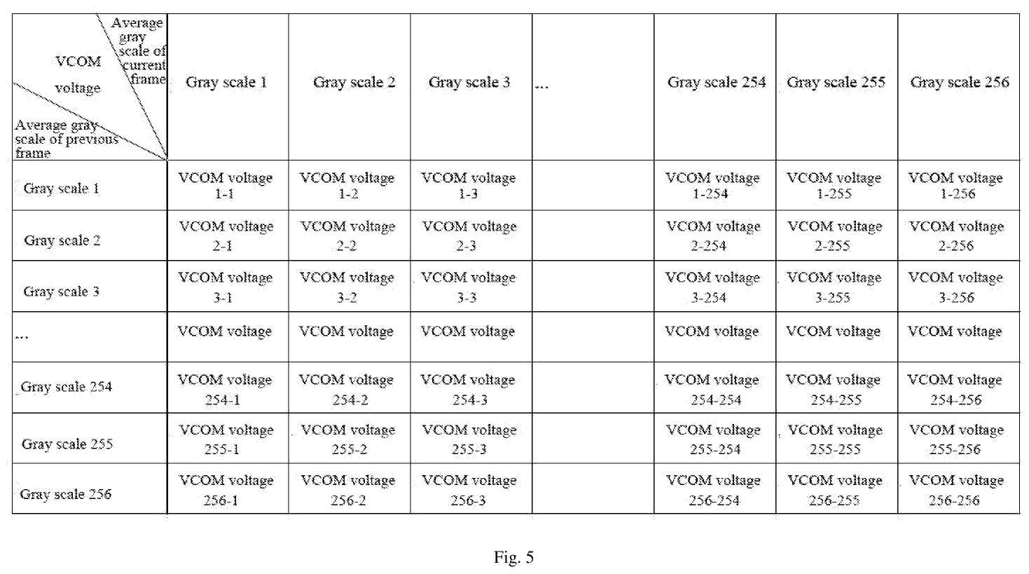

The gray scale data is an average gray scale value of one frame image. The adjusting value of the reference voltage of liquid crystal deflection is determined by a look-up table of gray scale value and voltage of liquid crystal deflection, based on the first gray scale value and the second gray scale value. Specifically, one average value would be calculated when a new frame data comes in, and this average value would be compared with the average value of the previous frame. As shown in FIG. 5, a table is stored in a EEPROM (Electrically Erasable Programmable read only memory), and a new VCOM value would be obtained by looking up the table.

Step S30, adjusting the reference voltage of liquid crystal deflection according to the adjusting value, to adjust the over driver value.

As the adjusting value of the reference voltage of the liquid crystal has been determined, OD (over driver) function could be adjusted by adjusting the reference voltage of liquid crystal deflection, VCOM. The liquid crystal image has been more stable, and the desired effects have been reached.

In one exemplary embodiment, with the objective of ensuring the displayed image's stability, after the operation of determining an adjusting value of a reference voltage of liquid crystal deflection based on the gray scale data, the method further includes:

judging if the reference voltage of liquid crystal deflection is placed between a first preset reference voltage and a second preset reference voltage, after adjusted according to the adjusting value;

if not, ending a flow process and controlling a voltage output according to a current reference voltage of liquid crystal deflection;

if yes, executing the reference voltage of liquid crystal deflection according to the adjusting value, to adjust the over driver value. Liquid crystal deflection voltage has a certain range, and Gamma voltage controls the gray scale of the screen in liquid crystal displaying. In normal condition, Gamma voltage ranges from G0-G14. Voltage difference between the Gamma voltage and the VCOM voltage brings a distinction in deflection angle of the liquid crystal and further a difference in brightness. The VCOM voltage, in the best scenario, is placed between G0 and G14, so as to obtain a best flickering of the liquid crystal screen. The first preset reference voltage value is G0 and the second preset reference voltage value is G14.

The present exemplary embodiment shortens a response time of the liquid crystal by acquiring gray scale data of an input image frame of the display device, determining an adjusting value of a reference voltage of liquid crystal deflection based on the gray scale data, and adjusting the reference voltage of liquid crystal deflection according to the adjusting value, to adjust an over driver value, which provides sufficient voltage to ensure the effect of the liquid crystal display, improves the stability of the liquid crystal display, and ensures the image effect of the liquid crystal display.

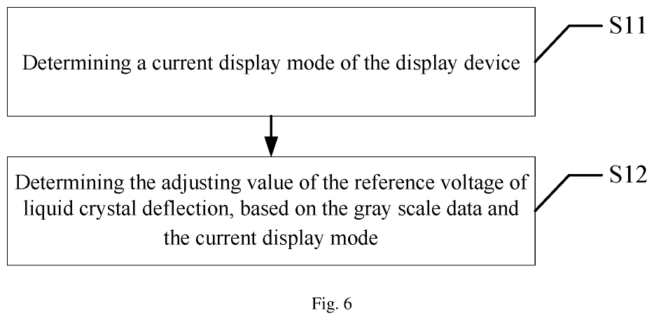

In one exemplary embodiment, FIG. 6 is referred to, in which a plurality of displaying modes are provided in the display device. the operation of determining the adjusting value of the reference voltage of liquid crystal deflection based on the gray scale data may include:

step S11, determining a current display mode of the display device;

step S12, determining the adjusting value of the reference voltage of liquid crystal deflection, based on the gray scale data and the current display mode.

A plurality of displaying modes may be provided in the display device, indicating different image effects and different liquid crystal deflection voltages required. The current display mode of the display device should be ascertained when adjusting the liquid crystal deflection voltage. The adjusting value of the reference voltage of liquid crystal deflection should be further determined, based on the gray scale data and the current display mode. According to characteristics of the display mode, some modification values for the adjusting value should be given regarding different display modes on the basis of the original adjusting value. For example, the display mode is A, correlating an adjusting value in the look-up table, whereas if display mode changes to B, “a” value should be modified on the basis of the adjusting value; if the display mode is C, then “c” value should be modified on the basis of the adjusting value.

In one exemplary embodiment, if the display mode is adjusted and shifted, the adjusted display mode has been determined after the display mode has been adjusted. The adjusting value of the reference voltage of liquid crystal deflection is redetermined, based on the adjusted display mode. The reference voltage of liquid crystal deflection is adjusted, based on redetermined adjusting value.

In the present exemplary embodiment, the liquid crystal adjustment has been more reliable, and the image effect of the display device has been improved, by means of modifying the liquid crystal deflection voltage regarding different display modes.

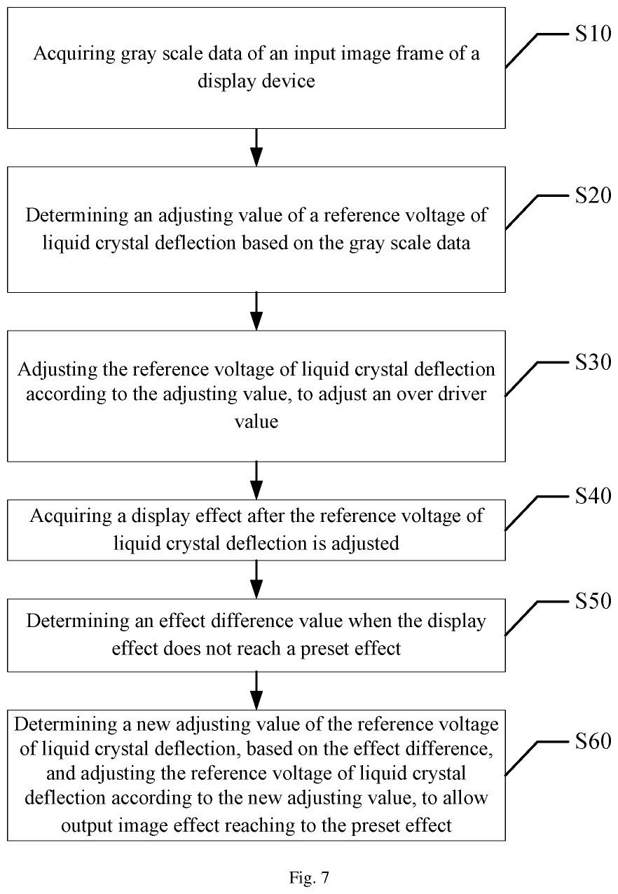

In one exemplary embodiment, referring to FIG. 7, after the operation of adjusting the reference voltage of liquid crystal deflection according to the adjusting value, to adjust the over driver value, the method may further includes:

step S40, acquiring an image effect after the reference voltage of liquid crystal deflection is adjusted;

step S50, determining an effect difference when the image effect does not reach a preset effect;

step S60, determining a new adjusting value of the reference voltage of liquid crystal deflection, based on the effect difference, and adjusting the reference voltage of liquid crystal deflection according to the new adjusting value, so that the image effect reaches the preset effect.

Since the image effect of the display device would be changed after adjusting the liquid crystal voltage, a mode for determining the adjusted effect is provided herein. Specifically, the image effect is acquired after the reference voltage of liquid crystal deflection is adjusted. The gray scale data would be compared with the preset gray scale data, judging if the preset effect has been reached. The effect difference is determined if the image effect does not reach a preset effect. A new adjusting value of the reference voltage of liquid crystal deflection is determined, based on the effect difference. And the reference voltage of liquid crystal deflection is adjusted according to the new adjusting value, so that the output image effect reaches the preset effect. If the preset effect has not been reached, a compensation has to be made to the adjusting value. The adjusting value of liquid crystal deflection is further determined based on the method mentioned above, according to the effect difference, i.e. the gray scale difference.

In another exemplary embodiment of the present application, the over driver voltage of the liquid crystal can be directly adjusted, if the preset effect has not been reached by means of adjusting the reference voltage of liquid crystal deflection based on the gray scale data, so that the OD function has been improved directly. Specifically, the over driver of the liquid crystal can be regulated by directly giving an adjusting value, or by directly adjusting over driver voltage of the liquid crystal according to the correlation relationship between the over driver value and the image effect difference. The image effect has thus been modified. The stability of the displayed image as well as the image effect have been improved by combination of adjusting both the voltages of the VCOM and OD.

Furthermore, the present application further provides a display device, the display device includes a display panel and a time schedule controller connected to the display panel. The time schedule controller is loaded with a data processing control device. The display panel performs displaying operations under the control of the time schedule controller. And the treatment of processing data stored in the time schedule controller is implemented by the display image adjusting method mentioned in above exemplary embodiments. The display image adjusting method loaded in the display image adjusting device, which is called and started by the time schedule controller, to perform adjustment of the liquid crystal deflection voltage and to further improve the image effect of the display device. The display device can be a mobile or a fixed display instrument, such as a television, a phone, a pad, machine display instrument and etc. The display device of present exemplary embodiment shortens a response time of the liquid crystal by acquiring gray scale data of an input image frame of the display device, determining an adjusting value of a reference voltage of liquid crystal deflection based on the gray scale data, and adjusting the reference voltage of liquid crystal deflection according to the adjusting value, to adjust an over driver value, which provides sufficient voltage to ensure the effect of the liquid crystal display, improves the stability of the liquid crystal display, and ensures the image effect of the liquid crystal display.

Further, the exemplary embodiment of the present application provides a computer readable storage medium. And the display image adjusting program is stored in the computer readable storage medium. The display image adjusting program performs the display image adjusting method mentioned in the above exemplary embodiments when executed by the processor.

It worth noting that the term “comprise”, “include”, or any other variants thereof is intended to encompass a non-exclusive inclusion, such that a process, method, article, or system that includes a plurality of elements which include those elements. It also includes other elements that are not explicitly listed, or elements that are inherent to such a process, method, item, or system. Without further limitation, an element defined by the phrase “comprising a . . . ” does not exclude the presence of any additional equivalent elements in the process, method, item, or system which includes the element.

The serial numbers of the embodiments of the present application are merely for the description, and do not represent superiority or inferiority of the embodiments.

Through the description of the above embodiments, those skilled in the art can clearly understand that the foregoing embodiment method can be implemented by means of software plus a necessary general hardware platform, and of course, can also by means of hardware. But in many cases, the former scenario is superior for implementation. On the basis of such understanding, the technical solution of the present application in nature, in other words, the part contributing to the prior art, can be embodied in the form of a software product. The computer software product is stored in a computer readable storage medium mentioned above (such as ROM/RAM, diskette or CD). The computer software product includes a plurality of instructions to enable a terminal device (could be a phone, a computer, a server, an air conditioner, or a network equipment and etc.) to execute the methods described in the each exemplary embodiment of the present application.

The above is only an optional embodiment of the present application, and not for limitation of the present application. Any equivalent structure or equivalent process transformation made using the specification and the drawings of the present application, or applied to other related technological fields in a direct or indirect way, should be all included in the protection scope of the present application.

What is claimed is:

1. A display image adjusting method, wherein, the method comprises:
acquiring gray scale data of an input image frame of a display device;
determining an adjusting value of a reference voltage of liquid crystal deflection based on the gray scale data; and
adjusting the reference voltage of liquid crystal deflection according to the adjusting value, to adjust an over driver value.

2. The method of claim 1, wherein, the operation of determining an adjusting value of a reference voltage of liquid crystal deflection based on the gray scale data comprises:
determining the gray scale data of a current input image frame from the gray scale data of the input image frame, and marking the gray scale data of the current input image as a first gray scale data;
determining the gray scale data of a previous input image frame from the gray scale data of the input image frame, and marking the gray scale data of the previous input image as a second gray scale data; and
determining the adjusting value of the reference voltage of liquid crystal deflection based on the first gray scale data and the second gray scale data.

3. The method of claim 2, wherein, the operation of determining the adjusting value of the reference voltage of liquid crystal deflection based on the first gray scale data and the second gray scale data comprises:
determining an average gray scale value of the previous input image frame based on the first gray scale data, and marking the average gray scale value of the previous input image frame as a first average gray scale value;
determining an average gray scale value of the current input image frame based on the second gray scale data, and marking the average gray scale value of the current input image frame as a second average gray scale value; and
determining the adjusting value of the reference voltage of liquid crystal deflection based on the first average gray scale value and the second average gray scale value.

4. The method of claim 3, wherein, the operation of determining the adjusting value of the reference voltage of liquid crystal deflection based on the first average gray scale value and the second average gray scale value is determined by a look-up table of gray scale value and voltage of liquid crystal deflection.

5. The method of claim 3, wherein, a plurality of display modes are provided in the display device;
the operation of determining the adjusting value of the reference voltage of liquid crystal deflection based on the gray scale data comprises:
determining a current display mode of the display device; and
determining the adjusting value of the reference voltage of liquid crystal deflection, based on the gray scale data and the current display mode.

6. The method of claim 3, wherein, after the operation of adjusting the reference voltage of liquid crystal deflection according to the adjusting value, to adjust an over driver value, the method further comprises:
acquiring an image effect after the reference voltage of liquid crystal deflection is adjusted;
determining an effect difference when the image effect does not reach a preset effect; and
determining a new adjusting value of the reference voltage of liquid crystal deflection, based on the effect difference, and adjusting the reference voltage of liquid crystal deflection according to the new adjusting value, to allow output image effect reaching to the preset effect.

7. The method of claim 2, wherein, a plurality of display modes are provided in the display device;
the operation of determining the adjusting value of the reference voltage of liquid crystal deflection based on the gray scale data comprises:
determining a current display mode of the display device; and
determining the adjusting value of the reference voltage of liquid crystal deflection, based on the gray scale data and the current display mode.

8. The method of claim 2, wherein, after the operation of adjusting the reference voltage of liquid crystal deflection according to the adjusting value, to adjust an over driver value, the method further comprises:
acquiring an image effect after the reference voltage of liquid crystal deflection is adjusted;
determining an effect difference when the image effect does not reach a preset effect; and
determining a new adjusting value of the reference voltage of liquid crystal deflection, based on the effect difference, and adjusting the reference voltage of liquid crystal deflection according to the new adjusting value, to allow output image effect reaching to the preset effect.

9. The method of claim 1, wherein, the acquired gray scale data of the input image frame is an average gray scale value of a current input image frame.

10. The method of claim 1, wherein the gray scale data of the input image frame comprises gray scale data of a current input image frame and/or gray scale data of a previous input image frame.

11. The method of claim 1, wherein after the operation of determining an adjusting value of a reference voltage of liquid crystal deflection based on the gray scale data, the method further comprises:
judging if the reference voltage of liquid crystal deflection is between a first preset reference voltage and a second preset reference voltage, after the reference voltage of liquid crystal deflection is adjusted according to the adjusting value;
if not, ending flow process and controlling voltage output according to a current reference voltage of liquid crystal deflection; and
if yes, executing the reference voltage of liquid crystal deflection according to the adjusting value, to adjust the over driver value.

12. The method of claim 1, wherein, a plurality of display modes are provided in the display device;
the operation of determining the adjusting value of the reference voltage of liquid crystal deflection based on the gray scale data comprises:
determining a current display mode of the display device; and
determining the adjusting value of the reference voltage of liquid crystal deflection, based on the gray scale data and the current display mode.

13. The method of claim 1, wherein, after the operation of adjusting the reference voltage of liquid crystal deflection according to the adjusting value, to adjust an over driver value, the method further comprises:
acquiring an image effect after the reference voltage of liquid crystal deflection is adjusted;
determining an effect difference when the image effect does not reach a preset effect; and
determining a new adjusting value of the reference voltage of liquid crystal deflection, based on the effect difference, and adjusting the reference voltage of liquid crystal deflection according to the new adjusting value, to allow output image effect reaching to the preset effect.

14. The method of claim 1, wherein, after the operation of adjusting the reference voltage of liquid crystal deflection according to the adjusting value, to adjust an over driver value, the method further comprises:
determining an adjusted display mode, after a display mode of the display device is adjusted;
redetermining the adjusting value of the reference voltage of liquid crystal deflection, based on the adjusted display mode; and
adjusting the reference voltage of liquid crystal deflection, based on the redetermined adjusting value.

15. A display device, wherein, the display device comprises: a memory, a processor, and a computer program stored in the memory and executed in the processor; the computer program performs the following steps when executed by the processor:
acquiring gray scale data of an input image frame of the display device;
determining an adjusting value of a reference voltage of liquid crystal deflection based on the gray scale data; and
adjusting the reference voltage of liquid crystal deflection according to the adjusting value, to adjust an over driver value.

16. The display device of claim 15, wherein, the computer program performs the following steps when executed by the processor:
wherein the operation of determining an adjusting value of a reference voltage of liquid crystal deflection based on the gray scale data comprises:
determining the gray scale data of a current input image frame from the gray scale data of the input image frame, and marking the gray scale data of the current input image as a first gray scale data;
determining the gray scale data of a previous input image frame from the gray scale data of the input image frame, and marking the gray scale data of the previous input image as a second gray scale data; and
determining the adjusting value of the reference voltage of liquid crystal deflection based on the first gray scale data and the second gray scale data.

17. The display device of claim 15, wherein the operation of determining the adjusting value of the reference voltage of liquid crystal deflection based on the first gray scale data and the second gray scale data comprises:
determining an average gray scale value of the previous image frame based on the first gray scale data, and marking the average gray scale value of the previous image frame as a first average gray scale value;
determining an average gray scale value of the current image image based on the second gray scale data, and marking the average gray scale value of the current image image as a second average gray scale value; and
determining the adjusting value of the reference voltage of liquid crystal deflection based on the first average gray scale value and the second average gray scale value.

18. The display device of claim 15, wherein a plurality of displaying modes are provided in the display device;
the operation of determining the adjusting value of the reference voltage of liquid crystal deflection based on the gray scale data comprises:
determining a current display mode of the display device; and
determining the adjusting value of the reference voltage of liquid crystal deflection, based on the gray scale data and the current display mode.

19. The display device of claim 15, wherein, after the operation of adjusting the reference voltage of liquid crystal deflection according to the adjusting value, to adjust an over driver value, the steps executed by the computer program further comprises:
acquiring an image effect after the reference voltage of liquid crystal deflection is adjusted;
determining an effect difference when the image effect does not reach a preset effect; and
determining a new adjusting value of the reference voltage of liquid crystal deflection, based on the effect difference, and adjusting the reference voltage of liquid crystal deflection according to the new adjusting value, to allow output image effect reaching to the preset effect.

20. A computer readable storage medium, wherein, a display image adjusting program is stored in the computer readable storage medium, the display image adjusting program performs the following steps when executed by the processor:
acquiring gray scale data of an input image frame of the display device;
determining an adjusting value of a reference voltage of liquid crystal deflection based on the gray scale data; and
adjusting the reference voltage of liquid crystal deflection according to the adjusting value, to adjust an over driver value.
